(19) United States
(12) Patent Application Publication
(10) Pub. No.: US 2025/0208925 A1
(43) Pub. Date: Jun. 26, 2025

(54) DEVICES AND METHODS FOR IMPROVED WORKLOAD-BALANCING PROCESSING BANDWIDTH ALLOCATION

(71) Applicant: SK Hynix NAND Product Solutions Corp. (dba Solidigm), Rancho Cordova, CA (US)

(72) Inventors: Teena Sebastian, Newark, CA (US); Mark Golez, Folsom, CA (US); David J. Pelster, Longmont, CO (US); Paul Ruby, Folsom, CA (US)

(21) Appl. No.: 18/390,390

(22) Filed: Dec. 20, 2023

(51) Int. Cl. G06F 9/50

(52) U.S. Cl. CPC G06F 9/5083

(57) ABSTRACT

A device and related method, the device including memory, communications circuitry, and processing circuitry. The processing circuitry allocates processing bandwidth of the device to process the received instructions and executes the instructions based on the allocated processing bandwidth using a first amount of free memory. If the used first amount of free memory is at least a first threshold, processing circuitry reduces the allocated processing bandwidth to process the received instructions based on the used first amount of free memory and continues to execute the instructions based on the reduced allocated processing bandwidth using a second amount of free memory of the device. If the used second amount of free memory is at least a second threshold, processing circuitry further reduces the allocated processing bandwidth to process the received instructions based on the used second amount of free memory, and allocates processing bandwidth to perform garbage collection of the memory.

### TECHNICAL FIELD

The present disclosure is directed to devices and methods with workload balancing during steady state workloads and workload transitions.

### SUMMARY

In accordance with the present disclosure, devices and methods are provided for load balancing the allocation of processing bandwidth to process instructions from a host and perform garbage collection/defragmentation of memory of the device (e.g., a storage device). The device (e.g., a solid state drive (SSD) device) includes memory, which may include memory blocks with pages or super pages of memory. The device and method disclosed herein may use firmware of the device along with processing circuitry to perform the load balancing of processing bandwidth allocation to perform a respective application/garbage collection of the respective memory blocks which hold invalid data associated with the respective application. The load balancing of allocated processing bandwidth with a small granularity of control enables precise transitions in processing bandwidth allocation and minimizes the amount of effective spare memory required within the memory while executing instruction workloads. The amount of minimum effective spare memory needed by the device restricts the overall performance and endurance of the device. The minimum effective spare memory is generally restricted by the smallest size of a portion of addressable memory to which host data may be written. The device and methods disclosed herein minimize the minimum effective spare memory, enable precise processing bandwidth allocation to execute host instructions, and enable the use of configurable thresholds of used amounts of free memory (e.g., spare memory) to determine how processing bandwidth is to be allocated between (a) executing host instructions and (b) performing garbage collection on at least one portion of the memory.

The device (e.g., SSD device) may include processing circuitry, which is configured to receive instructions from a host and allocate processing bandwidth of the device (i.e., a processor of the processing circuitry) to process the instructions based on a used amount of free memory. Initially, the processing circuitry allocates processing bandwidth to process the received instructions. In some embodiments, the processing circuitry allocates all available processing bandwidth to process the received instructions from the host. The processing circuitry executes the instructions from the host based on the allocated bandwidth with the used amount of free memory. As the instructions are executed by processing circuitry, valid host data may be written to available memory of the device, increasing the used amount of free memory. When the used amount of free memory is at least a first threshold, the processing circuitry reduces the allocated processing bandwidth to process the received instructions. As more free memory is used to store valid host data from the received instructions, the processing circuitry may determine that the used amount of free memory is at least a second threshold. If the used amount of free memory is at least the second threshold, the processing circuitry is then to further reduce the allocated processing bandwidth to process the host instructions and allocate processing bandwidth to perform garbage collection of the memory based on the allocated processing bandwidth to process the received instructions. In some embodiments, when the used amount of free memory is at least the second threshold, the processing circuitry may allocate a steady-state processing bandwidth to process the host instructions and to perform garbage collection on the memory of the device, respectively. In some embodiments, processing circuitry may perform garbage collection to remove invalid data (e.g., add to free memory) and store host data when processing host instructions (e.g., using free memory) at rates which cause the used amount of free memory to be between the second threshold and a third threshold. This range of used amount of free memory may be defined as the meander zone, which corresponds to allocated processing bandwidths within a processing bandwidth range, such as within five percent of the steady-state processing bandwidth. This device and methods provided herein improve the overall performance of the device and minimize the minimum effective spare memory of the device (e.g. a solid-state drive (SSD) device).

In some embodiments, the device (e.g., a storage device) is provided with a memory and processing circuitry that are communicatively coupled to each other. In some embodiments, the processing circuitry receives instructions from a host to be processed by the processing circuitry. In some embodiments, each instruction includes a destination address and host data which is to be stored at the destination address within the memory.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 shows an illustrative diagram of a system that includes a host and a device with processing circuitry, communications circuitry, and memory, in accordance with some embodiments of the present disclosure;

FIG. 2 shows a flowchart of illustrative steps of a process for load-balancing processing bandwidth allocation of a device, in accordance with some embodiments of the present disclosure;

FIGS. 3-5 show flowcharts of illustrative steps of subprocesses for load-balancing processing bandwidth allocation of a device, in accordance with some embodiments of the present disclosure; and

FIG. 6 shows an illustrative graph of processing bandwidth allocation in relation to used amounts of free memory of the device, in accordance with some embodiments of the present disclosure.

### DETAILED DESCRIPTION

In accordance with the present disclosure, devices and methods are provided for load balancing the allocated processing bandwidths to perform garbage collection and process instructions by processing circuitry of a device (e.g., an SSD device) using a used amount of free memory. The processing circuitry of the device (e.g., an SSD device) determines the respective processing bandwidth to (a) process instructions received from a host and (b) perform garbage collection of the memory of the device, based on the used amount of free memory which stores valid host data. In some embodiments, the processing circuitry may be configured to receive instructions from more than one host, and perform multiple instances of garbage collection to clear portions of memory at which host data has been written. Processing bandwidth allocation may vary based on the workload type (e.g., instruction operations) or workload state (e.g., transient state or steady state), which is directly related to the used amount of free memory. The function of allocated processing bandwidth to perform garbage collection and process host instructions is configurable to enable the methods and devices disclosed herein to be used for specified applications.

The processing circuitry is configured to receive instructions from a host and each instruction may be any one of a write instruction, read instruction, load instruction, or any suitable instruction which the host transmits to the device. Once the processing circuitry receives instructions from the host, the processing circuitry then allocates processing bandwidth of the device to process the received instructions. In some embodiments, the processing circuitry allocates a maximum processing bandwidth to process the host instructions. Processing bandwidth may have been allocated by processing circuitry to perform instructions from other applications (e.g., an internal application or an external application from another host). In some embodiments, the processing circuitry allocates the maximum available processing bandwidth of the device to process the instructions received from the host. Once the processing circuitry allocates processing bandwidth of the device to process the received instructions, the processing circuitry executes the instructions based on the allocated processing bandwidth using an amount of free memory of the device. When no amount of free memory is used by the device (i.e., all spare memory is available to be used), processing circuitry may allocate all available processing bandwidth to execute instructions received from the host. Therefore, processing circuitry executes the instructions, stores host data associated with the host instructions in memory without performing garbage collection on the memory.

As more free memory is used to store host data, the processing circuitry then determines that the used amount of free memory is at least a first threshold. When the processing circuitry determines that the used amount of free memory is at least the first threshold, the processing circuitry reduces the allocated processing bandwidth to process the received instructions based on the used amount of free memory. In some embodiments, no processing bandwidth is allocated for processing circuitry to perform garbage collection until the used amount of free memory is at least a second threshold. The processing circuitry continues to execute the instructions received from the host based on the reduced allocated processing bandwidth using the used amount of free memory of the device. In some embodiments, there is no processing bandwidth allocated for the processing circuitry to perform garbage collection, therefore the used amount of free memory will gradually reach the second threshold.

If the processing circuitry determines that the used amount of free memory is at least the second threshold, the processing circuitry further reduces the allocated processing bandwidth to process the received instructions based on the used amount of free memory. In some embodiments, processing circuitry may also perform garbage collection to remove invalid data from memory (e.g., add to free memory) and store host data when processing host instructions (e.g., use free memory) at rates which cause the processing circuitry to execute at processing bandwidth within a processing bandwidth range defined about a steady-state processing bandwidth. The processing circuitry is configured to allocate processing bandwidth to perform garbage collection of the memory based on the allocated processing bandwidth to process the received instructions. During garbage collection, once a respective memory block or memory page is cleared by the processing circuitry, the respective memory block or memory page is free memory to which new host data may be written. This process improves the overall performance and memory overhead needed by the device (e.g. a storage device) during transient and steady-state instruction workloads from a host.

For purposes of brevity and clarity, the features of the disclosure described herein are in the context of a device (e.g., an SSD device) having processing circuitry and memory. However, the principles of the present disclosure may be applied to any other suitable context in which load balancing of processing bandwidth allocated to perform garbage collection and to process host instructions is used based on the used amount of free memory. The device may include processing circuitry and memory, which are communicatively coupled to each other by network buses or interfaces. In some embodiments, the processing circuitry receives instructions from a host. In some embodiments, the instructions are sent from the host to the device via a network bus or interface.

In particular, the present disclosure provides devices and methods that provide precise load balancing of allocated processing bandwidths based on used amounts of free memory within the device. This improves the overall performance and endurance of the device while the processing circuitry performs transient state or steady state workloads (e.g., instructions from the host).

In some embodiments, a processor of the processing circuitry may be a highly parallelized processor capable of handling high bandwidths of incoming host data quickly (e.g., by starting simultaneous processing of instructions before completion of previously received instructions).

In some embodiments, the memory of the device disclosed herein may contain any of the following memory densities: single-level cells (SLCs), multi-level cells (MLCs), triple-level cells (TLCs), quad-level cells (QLCs), penta-level cells (PLCs), and any suitable memory density that is greater than five bits per memory cell.

In some embodiments, the device and methods of the present disclosure may refer to a storage device (e.g., an SSD device), which is communicatively coupled to a host (e.g., a host device) by a network bus or interface. In some embodiments, the device is capable of garbage collection, defragmentation or any other suitable memory management procedures while processing instructions from a host.

An SSD is a data storage device that uses integrated circuit assemblies as memory to store data persistently. SSDs have no moving mechanical components, and this feature distinguishes SSDs from traditional electromechanical magnetic disks, such as hard disk drives (HDDs) or floppy disks, which contain spinning disks and movable read/write heads. Compared to electromechanical disks, SSDs are typically more resistant to physical shock, run silently, have lower access time, and less latency.

Many types of SSDs use NAND-based flash memory which retains data without power and includes a type of non-volatile storage technology. Quality of Service (QOS) of an SSD may be related to the predictability of low latency and consistency of high input/output operations per second (IOPS) while servicing read/write input/output (I/O) workloads. This means that the latency or the I/O command completion time needs to be within a specified range without having unexpected outliers. Throughput or I/O rate may also need to be tightly regulated without causing sudden drops in performance level.

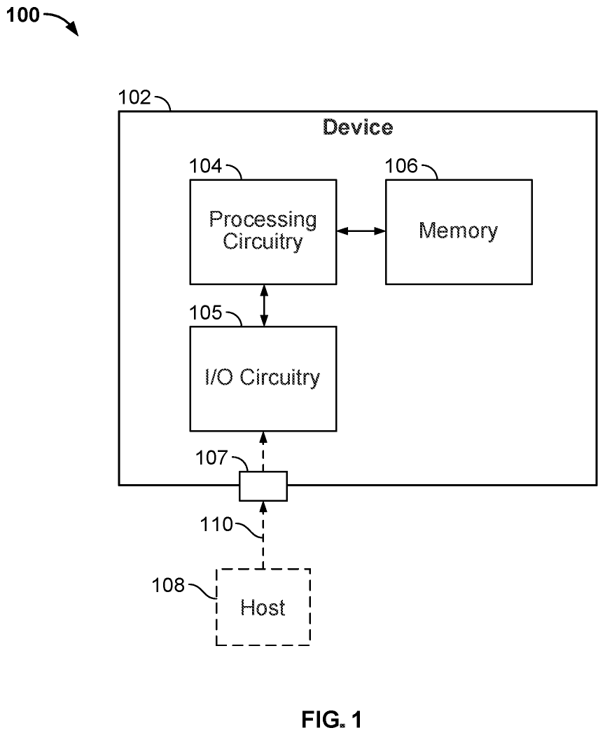

The subject matter of this disclosure may be better understood by reference to FIGS. 1-6.

FIG. 1 shows an illustrative diagram of a system 100 which includes a host 108 and device 102 with processing circuitry 104, input/output (I/O) circuitry 105, and memory 106, in accordance with some embodiments of the present disclosure. In some embodiments, device 102 may be a storage device such as a solid-state storage device (e.g., an SSD device). In some embodiments, processing circuitry 104 may include a processor or any suitable processing unit. In some embodiments, memory 106 may be non-volatile memory. It will be understood that the embodiments of the present disclosure are not limited to SSDs. For example, in some embodiments, device 102 may include a hard disk drive (HDD) device in addition to or in place of an SSD. In some embodiments, I/O circuitry 105 includes temporary memory (e.g., cache or any suitable volatile memory) to store received instructions (e.g., instruction 110 from host 108) via port 107.

The processing circuitry 104 is configured to receive instructions (e.g., instruction 110) from host 108 and each instruction may be any one of a write instruction, read instruction, load instruction, or any suitable instruction which host 108 transmits to device 102. Once processing circuitry 104 receives instructions (e.g., instruction 110) from host 108, the processing circuitry 104 then allocates processing bandwidth of device 102 to process the received instructions. In some embodiments, the processing circuitry 104 allocates a maximum processing bandwidth to process the host instructions. Processing bandwidth may have been allocated by processing circuitry 104 to perform instructions (e.g., instruction 110) from other applications (e.g., an internal application or an external application from another host). In some embodiments, the processing circuitry 104 allocates the maximum available processing bandwidth of device 102 to process the instructions received from the host 108. Once the processing circuitry 104 allocates processing bandwidth of device 102 to process the received instructions (e.g., instruction 110), the processing circuitry 104 executes the instructions based on the allocated processing bandwidth using an amount of free memory of device 102. When no amount of free memory is used by device 102 (i.e., all spare memory is available to be used), processing circuitry 104 may allocate all available processing bandwidth to execute instructions received from the host 108. Therefore, processing circuitry 104 executes the instructions (e.g., instruction 110) and stores host data associated with the host instructions in memory 106 without performing garbage collection on the memory 106.

As more free memory is used to store host data, the processing circuitry 104 then determines that the used amount of free memory is at least a first threshold. When the processing circuitry 104 determines that the used amount of free memory is at least the first threshold, the processing circuitry 104 reduces the allocated processing bandwidth to process the received instructions (e.g., instruction 110) based on the used amount of free memory. In some embodiments, no processing bandwidth is allocated for processing circuitry 104 to perform garbage collection until the used amount of free memory is at least a second threshold. The processing circuitry 104 continues to execute the instructions (e.g., instruction 110) received from the host 108 based on the reduced allocated processing bandwidth using the used amount of free memory of device 102. In some embodiments, there is no processing bandwidth allocated for the processing circuitry 104 to perform garbage collection, therefore the used amount of free memory will gradually reach the second threshold.

If the processing circuitry 104 determines that the used amount of free memory is at least the second threshold, the processing circuitry 104 further reduces the allocated processing bandwidth to process the received instructions (e.g., instruction 110) based on the used amount of free memory. In some embodiments, processing circuitry 104 may also perform garbage collection to remove invalid data from memory 106 (e.g., add to free memory) and store host data when processing host instructions (e.g., use free memory) at rates which cause the processing circuitry 104 to execute at processing bandwidth within a processing bandwidth range defined about a steady-state processing bandwidth. The processing circuitry 104 is configured to allocate processing bandwidth to perform garbage collection of the memory 106 based on the allocated processing bandwidth to process the received instructions (e.g., instruction 110). During garbage collection, once a respective memory block or memory page is cleared by the processing circuitry 104, the respective memory block or memory page is free memory to which new host data may be written.

Additionally, device 102 includes memory 106. In some embodiments, memory 106 includes any one or more of a non-volatile memory, such as Phase Change Memory (PCM), a PCM and switch (PCMS), a Ferroelectric Random Access Memory (FeRAM), or a Ferroelectric Transistor Random Access Memory (FeTRAM), a Memristor, a Spin-Transfer Torque Random Access Memory (STT-RAM), and a Magnetoresistive Random Access Memory (MRAM), any other suitable memory, or any combination thereof. In some embodiments, memory 106 is of a memory density, the memory density is any one of (a) single-level cell (SLC) memory density, (b) multi-level cell (MLC) memory density, (c) tri-level cell (TLC) memory density, (d) quad-level cell (QLC) memory density, (e) penta-level cell (PLC) memory density, or (f) a memory density of greater than 5 bits per memory cell. In some embodiments, processing circuitry 104 is communicatively coupled to memory 106 to store and access data in memory blocks or pages. In some embodiments, a data bus interface is used to transport write/read instructions or data. In some embodiments, memory 106 includes multiple memory die and/or multiple bands of memory, each of which spans across each memory die.

In some embodiments, device 102 also includes volatile memory, which may include any one or more volatile memory, such as Static Random Access Memory (SRAM). In some embodiments, volatile memory is configured to temporarily store data (e.g. instruction 110) during execution of operations by processing circuitry 104. In some embodiments, each of processing circuitry 104 and I/O circuitry 105 is communicatively coupled to volatile memory to store and access instruction 110 data of the volatile memory. In some embodiments, a data bus interface is used to transport instruction 110 data from volatile memory to processing circuitry 104. In some embodiments, volatile memory is communicatively coupled to memory 106, the volatile memory configured to function as a cache or temporary memory storage for memory 106. In some embodiments, a data bus interface between memory 106 and volatile memory provides a network bus for accessing or writing data to or from memory 106.

In some embodiments, the processor or processing unit of processing circuitry 104 may include a hardware processor, a software processor (e.g., a processor emulated using a virtual machine), or any combination thereof. The processor, also referred to herein as processing circuitry 104, may include any suitable software, hardware, or both for controlling memory 106 and processing circuitry 104. In some embodiments, device 102 may further include a multi-core processor. Memory 106 may also include hardware elements for non-transitory storage of instructions, commands, or requests.

Processing circuitry 104 is configured to process instructions received from a host, storing host data to at least one subset of memory 106 based on a destination memory address corresponding to the instruction (e.g., instruction 110) from host 108. In some embodiments, the processing circuitry 104 may store the host data in memory 106 in any other suitable manner, such as using a data placement method. Instruction 110 may originate from host 108 and include host data to be stored in memory 106 as well as a destination address indicative of a memory address of memory 106 at which to store the host data. When processing circuitry 104 stores host data to a respective memory address of memory 106, the processing circuitry 104 uses a portion of memory 106 which is indicated as free memory. Once host data is written to a portion of memory 106 corresponding to a memory address, the portion of memory 106 written to is indicated as used or unavailable. Other portions of memory 106 which may be indicated as used or unavailable are memory blocks which have previously been written to with valid data which is still in use to process subsequent instructions from the host, and memory portions which store invalid data which has yet been cleared by garbage collection. In some embodiments, the memory address of a particular subset of memory 106 within one or more of the memory dies of memory 106 may correspond to a memory band which spans across multiple dies. As free memory is used, the used amount of free memory increases, which alters the processing bandwidth allocated to process the instructions 110, until the processing circuitry 104 allocates processing bandwidth to perform garbage collection or defragmentation to clear portions of memory which store invalid data.

In some embodiments, device 102 may be a storage device (for example, SSD device) which may include one or more packages of memory dies (e.g., memory 106), where each die includes storage cells. In some embodiments, the storage cells are organized into pages or super pages, such that pages and super pages are organized into blocks. In some embodiments, each storage cell can store one or more bits of information.

For purposes of clarity and brevity, and not by way of limitation, the present disclosure is provided in the context of load balancing processing bandwidth allocation for processing circuitry 104 to perform instructions from a host and garbage collection/defragmentation of memory 106 of the device 102. The process of load balancing processing bandwidth allocation for processing circuitry 104 based on the used amount of free memory may be configured by any suitable software, hardware, or both for implementing such features and functionalities. Load balancing of processing bandwidths, as disclosed, may be at least partially implemented in, for example, device 102 (e.g., as part of processing circuitry 104, or any other suitable device). For example, for a solid-state storage device (e.g., device 102), load balancing of the processing bandwidths to process host instructions and to perform garbage collection may be implemented in processing circuitry 104. The precise load balancing of processing bandwidth enables device 102 to provide improved performance of the device 102 as well as minimizes the minimum effective spare memory in memory 106. The minimized minimum effective spare memory enables processing bandwidth to be allocated to process host instructions within a larger range of used amounts of free memory, reducing the memory overhead during the runtime of device 102.

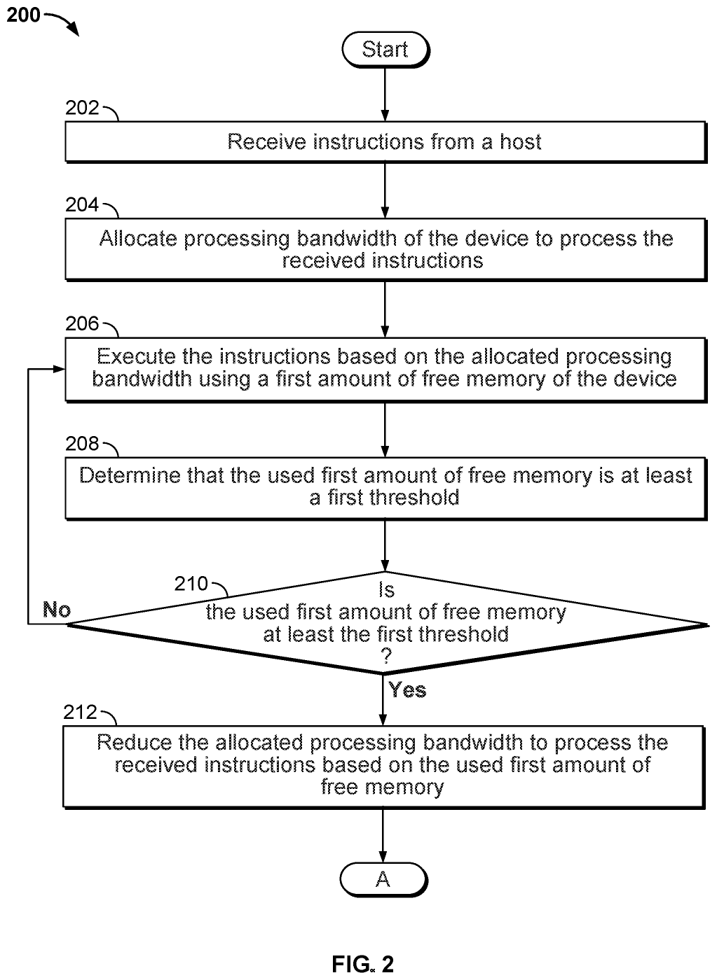

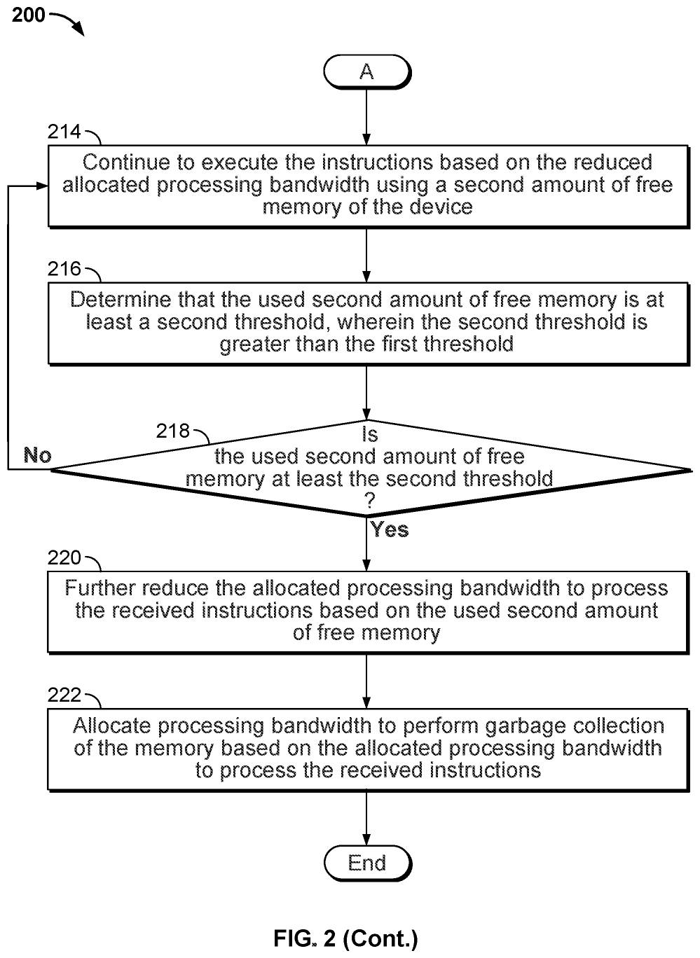

FIG. 2 shows a flowchart of illustrative steps of process 200 for load-balancing processing bandwidth allocation of a device, in accordance with some embodiments of the present disclosure. In some embodiments, the referenced system, device, processing circuitry, I/O circuitry, memory, port, host, and instruction may be implemented as system 100, device 102, processing circuitry 104, I/O circuitry 105, memory 106, port 107, host 108, and instruction 110, respectively. In some embodiments, the process 200 can be modified by, for example, having steps rearranged, changed, added, and/or removed.

At step 202, the processing circuitry receives instructions from the host. In some embodiments, processing circuitry receives the instruction through the I/O circuitry. The instructions may include one or more write instructions, read instructions, load instructions, or any suitable instructions which the host transmits to the device. In some embodiments, the instructions received are temporarily stored in a queue or any suitable volatile memory. In some embodiments, the instructions are temporarily stored in I/O circuitry before being executed by processing circuitry. Once the processing circuitry receives instructions from the host, the processing circuitry then allocates processing bandwidth of the device to process the received instructions, at step 204.

At step 204, the processing circuitry allocates processing bandwidth of the device to process the received instructions. In some embodiments, the processing circuitry allocates a maximum processing bandwidth to process the host instructions. Processing bandwidth may have been allocated by processing circuitry to perform instructions from other applications (e.g., an internal application or an external application from another host). In some embodiments, the processing circuitry allocates the maximum available processing bandwidth of the device to process the instructions received from the host. This initial processing bandwidth allocated by processing circuitry is configurable and dependent on the number of applications or hosts from which the instructions are sent and the types of applications performed by the processing circuitry. In addition, as no amount of free memory is used by the device, there is no invalid or stale data to warrant processing bandwidth to be allocated to perform garbage collection by the processing circuitry. Once the processing circuitry allocates processing bandwidth of the device to process the received instructions, the processing circuitry executes the instructions based on the allocated processing bandwidth, at step 206.

At step 206, the processing circuitry executes the instructions based on the allocated processing bandwidth using a first amount of free memory of the device. When no amount of free memory is used by the device (i.e., all spare memory is available to be used), processing circuitry may allocate all available processing bandwidth to execute instructions received from the host. Therefore, processing circuitry executes the instructions, stores host data associated with the host instructions in memory without performing garbage collection on the memory.

At step 208, the processing circuitry determines that the used first amount of free memory is at least a first threshold. In some embodiments, the first threshold is configurable based on the application or host communicatively coupled to the device. In addition, the first threshold is defined to be less than the second threshold. In some embodiments, the used amounts of free memory (e.g., the used first amount of free memory) is determined by determining the amount of free memory used to store valid data which may be used to process subsequent host instructions, and determining the amount of free memory used to store invalid data which is to be cleared by garbage collection.

At step 210, the processing circuitry continues to another step depending on the determination of whether the used first amount of free memory is at least the first threshold, at step 208. When the processing circuitry determines that the used first amount of free memory is less than the first threshold, the processing circuitry continues to execute the instructions based on the allocated processing bandwidth based on the used first amount of free memory, at 206. If the processing circuitry determines that the used amount of free memory is at least the first threshold, the processing circuitry reduces the allocated processing bandwidth to process the received instructions based on the used first amount of free memory, at step 212.

At step 212, the processing circuitry reduces the allocated processing bandwidth to process the received instructions based on the used first amount of free memory. In some embodiments, as the used first amount of free memory is at least the first threshold and increases (e.g., there is less memory which is free or cleared to be used), the processing circuitry reduces the processing bandwidth allocated to execute the received instructions from the host. In some embodiments, the processing bandwidth allocated to execute the received instructions from the host decreases in an inverse relationship as the used first amount of free memory increases. The function of the processing bandwidth allocated by the processing circuitry may be represented by a series of steps, wherein the smallest possible step in the used amount of free memory is defined by the smallest unit of memory to which data may be written. The rate at which the processing bandwidth allocated to execute the instructions is reduced by processing circuitry may be based on (a) the initial amount of processing bandwidth allocated to execute the host instructions when the used first amount of free memory is less than the first threshold and (b) the steady-state processing bandwidth allocated by the processing circuitry to execute the host instructions when the used second amount of free memory is the second threshold. In some embodiments, no processing bandwidth is allocated for processing circuitry to perform garbage collection until the used second amount of free memory is at least the second threshold.

At step 214, the processing circuitry continues to execute the instructions received from the host based on the reduced allocated processing bandwidth using a second amount of free memory of the device. In some embodiments, there is no processing bandwidth allocated for the processing circuitry to perform garbage collection, therefore the used second amount of free memory will gradually reach the second threshold, at step 216.

At step 216, the processing circuitry determines that the used second amount of free memory is at least a second threshold, which is greater than the first threshold.

At step 218, the processing circuitry continues to another step depending on the determination of whether the used second amount of free memory is at least the second threshold. When the processing circuitry determines that the used second amount of free memory is less than the second threshold, the processing circuitry continues to execute the instructions based on the reduced allocated processing bandwidth using a second amount of free memory, at step 214. If the processing circuitry determines that the used second amount of free memory is at least the second threshold, the processing circuitry further reduces the allocated processing bandwidth to process the received instructions based on the used second amount of free memory, at step 220.

At step 220, the processing circuitry further reduces the allocated processing bandwidth to process the received instructions based on the used second amount of free memory. In some embodiments, processing circuitry may perform garbage collection (at step 222) to remove invalid data from memory (e.g., add to free memory) and store host data when processing host instructions (e.g., use free memory) at rates which cause the used second amount of free memory to be between the second threshold and a third threshold. This range of used amount of free memory may be defined as the meander zone, which corresponds to allocated processing bandwidths within a processing bandwidth range, such as within five percent of the steady-state processing bandwidth. In some embodiments, the processing bandwidth range may be configured based on the application or host, the types of workloads processed by processing circuitry, and the steady-state processing bandwidth.

At step 222, the processing circuitry allocates processing bandwidth to perform garbage collection of the memory based on the allocated processing bandwidth to process the received instructions. In some embodiments, the garbage collection performed by the processing circuitry is any suitable garbage collection or defragmentation process. In some embodiments, the processing circuitry performs garbage collection based on the allocated processing bandwidth by clearing invalid or stale data stored within at least one portion of memory (e.g., a section of a memory block or page of memory). In some embodiments, garbage collection may also perform defragmentation by copying valid data of a first memory block to a second, free memory block and then clearing the first memory block such that it may be used to store further host data. During garbage collection, once a respective memory block or memory page is cleared by the processing circuitry, the respective memory block or memory page is free memory to which new host data may be written. In some embodiments, the processing bandwidths to process the host instructions and perform garbage collection may be allocated about the steady-state processing bandwidth. For example, as the allocated processing bandwidth to process the host instructions decreases at a respective rate as the used amount of memory increases from the second threshold, the allocated processing bandwidth to perform garbage collection increases at the same respective rate.

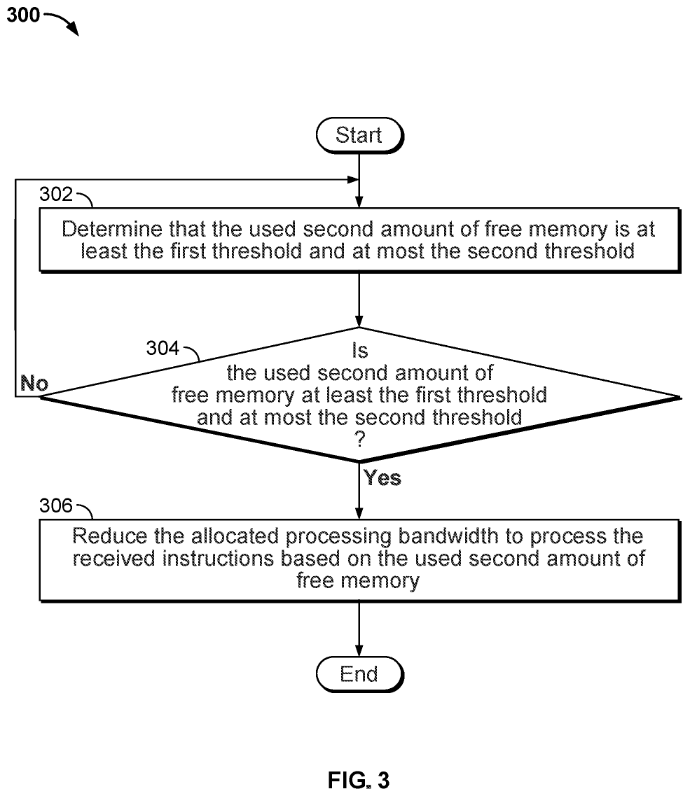

FIG. 3 shows a flowchart of illustrative steps of subprocess 300 for load-balancing processing bandwidth allocation of a device, in accordance with some embodiments of the present disclosure. In some embodiments, the referenced system, device, processing circuitry, I/O circuitry, memory, port, host, and instruction may be implemented as system 100, device 102, processing circuitry 104, I/O circuitry 105, memory 106, port 107, host 108, and instruction 110, respectively. In some embodiments, subprocess 300 can be modified by, for example, having steps rearranged, changed, added, and/or removed.

At step 302, the processing circuitry determines that the used second amount of free memory is at least the first threshold and at most the second threshold. In some embodiments, the range of the used amounts of free memory between the first threshold and the second threshold is defined as a transient state. In some embodiments, the second threshold is configurable based on the application or host communicatively coupled to the device. In addition, the second threshold is greater than the first threshold and less than the third threshold.

At step 304, the processing circuitry continues to another step depending on the determination of whether the used second amount of free memory is at least the first threshold and at most the second threshold. When the processing circuitry determines that the used second amount of free memory is less than the first threshold or greater than the second threshold, the processing circuitry continues to execute the instructions based on the allocated processing bandwidth using the second amount of free memory and determines whether the used second amount of free memory is at least the first threshold and at most the second threshold, at step 302. If the processing circuitry determines that the used second amount of free memory is at least the first threshold and at most the second threshold, the processing circuitry reduces the allocated processing bandwidth to process the received instructions based on the used second amount of free memory, at step 306.

At step 306, the processing circuitry reduces the allocated processing bandwidth to process the received instructions based on the used second amount of free memory. The reduction of allocated processing bandwidths associated with the range of the used second amount of free memory from the first threshold to the second threshold is indicative of ramping down the rate at which host instructions are processed until the processing circuitry executes the host instructions at a steady-state processing bandwidth while garbage collection is performed. The rate at which the processing bandwidth allocated to execute the instructions reduces may be based on (a) the initial amount of processing bandwidth allocated to execute the host instructions when the used second amount of free memory is less than the first threshold and (b) the steady-state processing bandwidth allocated to execute the host instructions when the used second amount of free memory is the second threshold. In some embodiments, no processing bandwidth is allocated for processing circuitry to perform garbage collection until the used second amount of free memory is at least the second threshold.

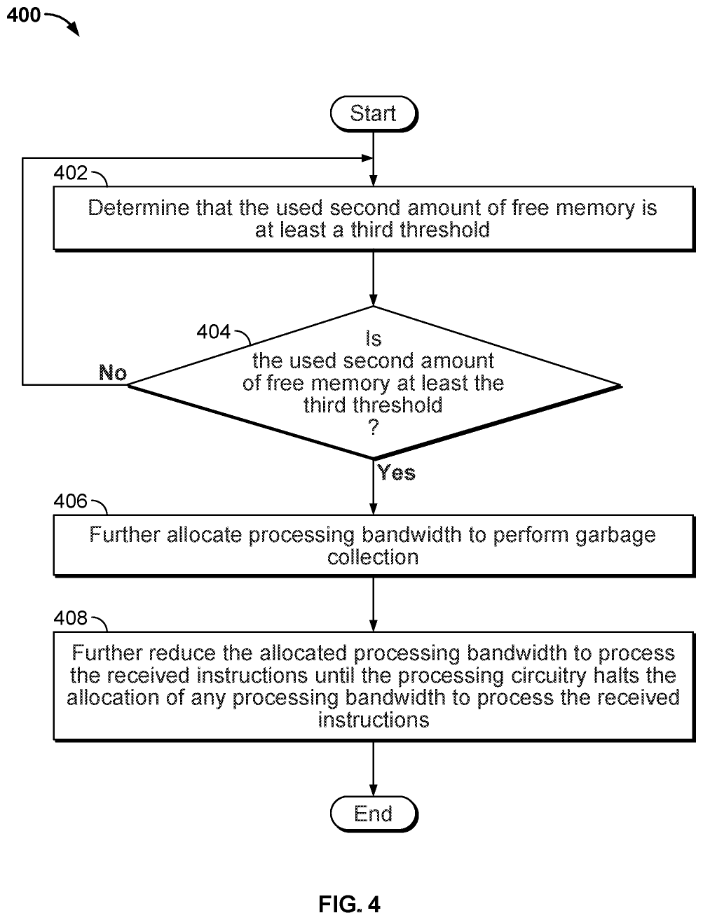

FIG. 4 shows another flowchart of illustrative steps of subprocess 400 for load-balancing processing bandwidth allocation of a device, in accordance with some embodiments of the present disclosure. In some embodiments, the referenced system, device, processing circuitry, I/O circuitry, memory, port, host, and instruction may be implemented as system 100, device 102, processing circuitry 104, I/O circuitry 105, memory 106, port 107, host 108, and instruction 110, respectively. In some embodiments, subprocess 400 can be modified by, for example, having steps rearranged, changed, added, and/or removed.

At step 402, the processing circuitry determines that the used second amount of free memory is at least a third threshold. In some embodiments, the third threshold is configurable based on the application or host communicatively coupled to the device. In addition, the third threshold is greater than the second threshold and less than the fourth threshold.

At step 404, the processing circuitry continues to another step depending on the determination of whether the used second amount of free memory is at least the third threshold. When the processing circuitry determines that the used second amount of free memory is less than the third threshold, the processing circuitry continues to execute the instructions based on the allocated processing bandwidth using the second amount of free memory and determines whether the used second amount of free memory is at least the third threshold, at step 402. If the processing circuitry determines that the used second amount of free memory is at least the third threshold, the processing circuitry further allocates processing bandwidth to perform garbage collection, at step 406.

At step 406, the processing circuitry further reduces the allocated processing bandwidth to process the received instructions until the processing circuitry halts the allocation of any processing bandwidth to process the received instructions. In some embodiments, while the used second amount of free memory is at least the third threshold, the processing circuitry further reduces the processing bandwidth allocated to process the host instructions to avoid the used second amount of free memory reaching the fourth threshold. In some embodiments, if the used second amount of free memory reaches the fourth threshold, the processing circuitry enters an urgency mechanism, which impacts the overall performance of the device.

At step 408, the processing circuitry allocates all available processing bandwidth to perform garbage collection. The processing circuitry further allocates processing bandwidth to perform garbage collection to clear invalid data in the memory. In some embodiments, the garbage collection may clear invalid data at a rate which reduces the used second amount of free memory to a value between the second threshold and the third threshold, and therefore the processing circuitry may operate around the steady-state processing bandwidth.

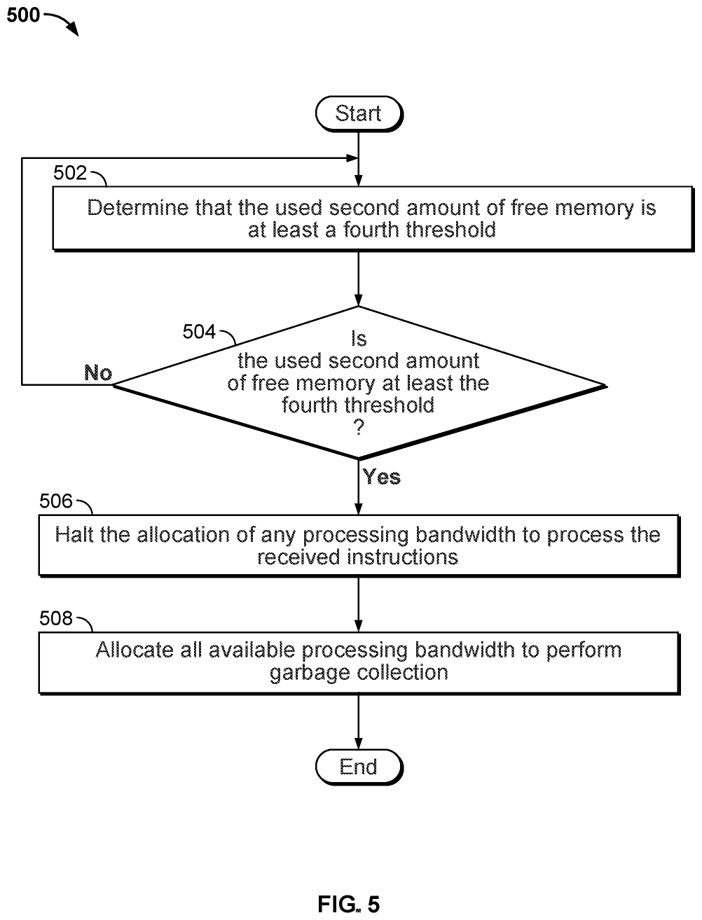

FIG. 5 shows another flowchart of illustrative steps of subprocess 500 for load-balancing processing bandwidth allocation of a device, in accordance with some embodiments of the present disclosure. In some embodiments, the referenced system, device, processing circuitry, I/O circuitry, memory, port, host, and instruction may be implemented as system 100, device 102, processing circuitry 104, I/O circuitry 105, memory 106, port 107, host 108, and instruction 110, respectively. In some embodiments, subprocess 500 can be modified by, for example, having steps rearranged, changed, added, and/or removed.

At step 502, the processing circuitry determines that the used second amount of free memory is at least a fourth threshold. In some embodiments, the fourth threshold is configurable based on the application or host communicatively coupled to the device. In addition, the fourth threshold is greater than the third threshold and no greater than the minimum effective spare memory.

At step 504, the processing circuitry continues to another step depending on the determination of whether the used second amount of free memory is at least the fourth threshold. When the processing circuitry determines that the used second amount of free memory is less than the fourth threshold, the processing circuitry continues to execute the instructions based on the allocated processing bandwidth using the second amount of free memory and determines whether the used second amount of free memory is at least the fourth threshold, at step 502. If the processing circuitry determines that the used second amount of free memory is at least the fourth threshold, the processing circuitry halts the allocation of any processing bandwidth to process the received instructions, at step 506.

At step 506, the processing circuitry halts the allocation of any processing bandwidth to process the received instructions. In some embodiments, this procedure may be defined as the urgency mechanism of the device. By halting the processing of any further host instructions, the processing circuitry is allowed to allocate further processing bandwidth to perform garbage collection or perform data recovery of failed memory portions, at step 508.

At step 508, the processing circuitry allocates all available processing bandwidth to perform garbage collection. In addition, the device may perform active data recovery or further garbage collection/defragmentation in order to recover failed memory blocks, memory dies or other portions of memory. In some embodiments, the fourth threshold corresponds to the minimum effective spare memory. In some embodiments, when a memory block or memory die fails, the amount of available memory drops (e.g., the used second amount of free memory increases) such that the device causes the urgency mechanism. The devices and methods provided herein minimize the minimum effective spare memory needed and therefore allow for a higher tolerance for the used second amount of free memory before requiring to perform the urgency mechanism, reducing memory overhead needed for the device.

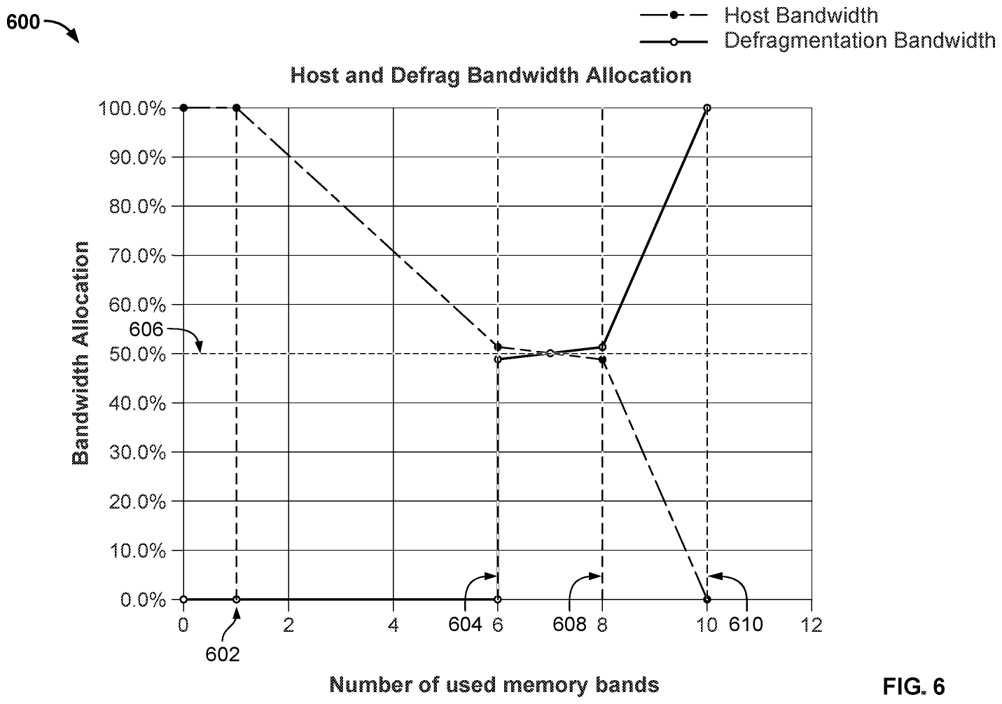

FIG. 6 shows an illustrative graph 600 of processing bandwidth allocation in relation to used amounts of free memory of the device, in accordance with some embodiments of the present disclosure. Graph 600 shows an example relationship of the allocated processing bandwidths used to (a) execute instructions from a host and (b) garbage collection, with respect to the amount of free memory in memory (e.g., memory 106) of the device. In some embodiments, the processing circuitry may receive instructions from (a) more than one host, (b) more than one application within the host, or (c) more than one virtual machine of the host. In some embodiments, the relationship between the processing bandwidth allocated to perform an application (e.g., execute instructions from a host or garbage collection) and the amount of free memory is configurable.

Initially, when no amount of free memory is used by the device (i.e., all spare memory is available to be used), processing circuitry may allocate all available processing bandwidth to execute instructions received from a host. Graph 600 illustrates that processing circuitry initially allocates all available processing bandwidth to execute the received instructions. The processing bandwidth initially allocated by processing circuitry is configurable and dependent on the number of applications or hosts from which the instructions are sent and the types of applications performed by the processing circuitry. In addition, as no amount of free memory is used by the device, there is no invalid or stale data to warrant processing bandwidth to be allocated to perform garbage collection by the processing circuitry.

In some embodiments, when the used amount of free memory is at least a first threshold 602, the processing circuitry reduces the processing bandwidth allocated to execute the instructions received from the host. In some embodiments, as the used amount of free memory is at least the first threshold 602 and increases (e.g., there is less memory which is free or cleared to be used), the processing circuitry reduces the processing bandwidth allocated to execute the received instructions from the host. In some embodiments, the processing bandwidth allocated to execute the received instructions from the host decreases in an inverse relationship as the used amount of free memory increases. The function of the processing bandwidth allocated by the processing circuitry may be represented by a series of steps, wherein the smallest possible step in the used amount of free memory is defined by the smallest unit of memory to which data may be written. The transition of allocated processing bandwidths associated with the range of the used amount of free memory from the first threshold 602 to the second threshold 604 is indicative of ramping down the rate at which host instructions are processed until the processing circuitry executes the host instructions at a steady-state processing bandwidth 606 while garbage collection is performed. The rate at which the processing bandwidth allocated to execute the instructions reduces may be based on (a) the initial amount of processing bandwidth allocated to execute the host instructions when the used amount of free memory is less than the first threshold 602 and (b) the allocated processing bandwidth to execute the host instructions when the used amount of free memory is the second threshold 604. As illustrated in graph 600, no processing bandwidth is allocated for processing circuitry to perform garbage collection until the used amount of free memory is at least a second threshold 604.

In some embodiments, when the used amount of free memory is at least the second threshold 604, the processing circuitry further reduces the processing bandwidth allocated to execute the host instructions. In some embodiments, as shown in graph 600, when the used amount of free memory is at least the second threshold 604, the processing circuitry allocates processing bandwidth to perform garbage collection on the memory of the device. In some embodiments, the garbage collection performed by the processing circuitry is any suitable garbage collection or defragmentation process. In some embodiments, the processing circuitry performs garbage collection based on the allocated processing bandwidth by clearing invalid or stale data stored within at least one portion of memory (e.g., a section of a memory block or page of memory). In some embodiments, garbage collection may also perform defragmentation by copying valid data of a first memory block to a second, free memory block and then clearing the first memory block such that it may be used for further host data. During garbage collection, once a respective memory block or memory page is cleared by the processing circuitry, the respective memory block or memory page is free memory to which new host data may be written. In some embodiments, processing circuitry may perform garbage collection to remove invalid data from memory (e.g., add to free memory) and store host data when processing host instructions (e.g., use free memory) at rates which cause the used amount of free memory to be between the second threshold 604 and the third threshold 608. This range of used amount of free memory may be defined as the meander zone, which corresponds to allocated processing bandwidths within a processing bandwidth range, such as within five percent of the steady-state processing bandwidth 606. The processing bandwidth range may be configured based on the application or host, the types of workloads processed by processing circuitry, and the steady-state processing bandwidth 606. In some embodiments, as shown in graph 600, the processing bandwidths to process the host instructions and perform garbage collection may be allocated about the steady-state processing bandwidth 606 within the processing bandwidth range. For example, as the allocated processing bandwidth to process the host instructions decreases at a respective rate as the used amount of memory increases from the second threshold 604 to the third threshold 608, the allocated processing bandwidth to perform garbage collection increases at the same respective rate.

As the used amount of free memory increases to at least a third threshold 608, the used amount of free memory approaches a fourth threshold 610, which may be defined by the minimum effective spare memory. In some embodiments, while the used amount of free memory is at least the third threshold 608, the processing circuitry further reduces the processing bandwidth allocated to process the host instructions to avoid the used amount of free memory reaching the fourth threshold 610. In addition, processing circuitry further allocates processing bandwidth to perform garbage collection to clear invalid data in the memory. In some embodiments, the garbage collection may clear invalid data at a rate which reduces the used amount of free memory to a value between the second threshold 604 and third threshold 608, and therefore the processing circuitry may operate around the steady-state processing bandwidth 606. In some embodiments, if the used amount of free memory reaches the fourth threshold 610, the processing circuitry enters an urgency mechanism. In some embodiments, the urgency mechanism causes the processing of host instructions by the processing circuitry to halt, therefore no processing bandwidth is allocated to process instructions from the host. In addition, the device may perform active data recovery or further garbage collection/defragmentation in order to recover failed memory blocks or memory dies. In some embodiments, the fourth threshold 610 corresponds to the minimum effective spare memory. In some embodiments, when a memory block or memory die fails, the amount of available memory drops (e.g., the used amount of free memory increases) such that the device causes the urgency mechanism. The devices and methods provided herein minimize the minimum effective spare memory needed and therefore allow for a higher tolerance for the used amount of free memory before requiring to perform the urgency mechanism, reducing memory overhead needed for the device.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A method for load-balancing processing bandwidth allocation of a device, the method comprising:
receiving, by processing circuitry of the device, instructions from a host;
allocating, by the processing circuitry, processing bandwidth of the device to process the received instructions;
executing, by the processing circuitry, the instructions based on the allocated processing bandwidth using a first amount of free memory of the device;
determining, by the processing circuitry, that the used first amount of free memory is at least a first threshold;
in response to the determining that the used first amount of free memory is at least the first threshold:
reducing, by the processing circuitry, the allocated processing bandwidth to process the received instructions based on the used first amount of free memory;
continuing executing, by the processing circuitry, the instructions based on the reduced allocated processing bandwidth using a second amount of free memory of the device;
determining, by the processing circuitry, that the used second amount of free memory is at least a second threshold, wherein the second threshold is greater than the first threshold; and
in response to the determining that the used second amount of free memory is at least the second threshold:
further reducing, by the processing circuitry, the allocated processing bandwidth to process the received instructions based on the used second amount of free memory; and
allocating processing bandwidth to perform garbage collection of the memory based on the allocated processing bandwidth to process the received instructions.

2. The method of claim 1, further comprising:
determining that the used second amount of free memory is at least the first threshold and at most the second threshold; and
in response to the determining that the used second amount of free memory is at least the first threshold and at most the second threshold:
reducing the allocated processing bandwidth to process the received instructions based on the used second amount of free memory.

3. The method of claim 2, wherein reducing the allocated processing bandwidth to process the received instructions comprises reducing the allocated processing bandwidth to process the received instructions in an inverse relationship with the used second amount of free memory.

4. The method of claim 1, wherein in response to the determining that the used second amount of free memory is at least the second threshold:
inversely modifying each of the respective allocated processing bandwidths to (a) process the received instructions and (b) perform garbage collection about a processing bandwidth value of normal operation of the device.

5. The method of claim 1, further comprising:
determining that the used second amount of free memory is at least a third threshold; and
in response to the determining that the used second amount of free memory is at least the third threshold:
further allocating processing bandwidth to perform garbage collection; and
further reducing the allocated processing bandwidth to process the received instructions until the used second amount of free memory is at most a fourth threshold.

6. The method of claim 5, further comprising:
determining that the used second amount of free memory is at least the fourth threshold; and
in response to the determining that the used second amount of free memory is at least the fourth threshold:
halting the allocation of any processing bandwidth to process the received instructions; and
allocating all available processing bandwidth to perform garbage collection.

7. A device comprising:
memory comprising available free memory;
communications circuitry to receive instructions from a host; and
processing circuitry to:
allocate processing bandwidth of the device to process the received instructions;
execute the instructions based on the allocated processing bandwidth using a first amount of free memory;
determine that the used first amount of free memory is at least a first threshold;
in response to the determination that the used first amount of free memory is at least the first threshold:
reduce the allocated processing bandwidth to process the received instructions based on the used first amount of free memory;
continue to execute the instructions based on the reduced allocated processing bandwidth using a second amount of free memory of the device;
determine that the used second amount of free memory is at least a second threshold, wherein the second threshold is greater than the first threshold; and
in response to the determination that the used second amount of free memory is at least the second threshold:
further reduce the allocated processing bandwidth to process the received instructions based on the used second amount of free memory; and
allocate processing bandwidth to perform garbage collection of the memory based on the allocated processing bandwidth to process the received instructions.

8. The device of claim 7, wherein the processing circuitry is further to:
determine that the used second amount of free memory is at least the first threshold and at most the second threshold; and
in response to the determination that the used second amount of free memory is at least the first threshold and at most the second threshold:
reduce the allocated processing bandwidth to process the received instructions based on the used second amount of free memory.

9. The device of claim 8, wherein to reduce the allocated processing bandwidth to process the received instructions the processing circuitry is to reduce the allocated processing bandwidth to process the received instructions in an inverse relationship with the used second amount of free memory.

10. The device of claim 7, wherein in response to the determination that the used second amount of free memory is at least the second threshold the processing circuitry is to:
inversely modify each of the respective allocated processing bandwidths to (a) process the received instructions and (b) perform garbage collection about a processing bandwidth value of normal operation of the device.

11. The device of claim 7, wherein the processing circuitry is further to:
determine that the used second amount of free memory is at least a third free space consumption threshold; and
in response to the determination that the used second amount of free memory is at least the third threshold:
further allocate processing bandwidth to perform garbage collection; and
further reduce the allocated processing bandwidth to process the received instructions until the used second amount of free memory is at most a fourth threshold.

12. The device of claim 11, wherein the processing circuitry is further to:
determine that the used second amount of free memory is at least the fourth threshold; and
in response to the determination that the used second amount of free memory is at least the fourth threshold:
halt the allocation of any processing bandwidth to process the received instructions; and
allocate all available processing bandwidth to perform garbage collection.

13. A non-transitory computer-readable medium having non-transitory computer-readable instructions encoded thereon that, when executed by processing circuitry, cause the processing circuitry to:
receive instructions from a host;
allocate processing bandwidth of the non-transitory computer-readable medium to process the received instructions;
execute the instructions based on the allocated processing bandwidth using a first amount of free memory;
determine that the used first amount of free memory is at least a first threshold;
in response to the determination that the used first amount of free memory is at least the first threshold:
reduce the allocated processing bandwidth to process the received instructions based on the used first amount of free memory;
continue to execute the instructions based on the reduced allocated processing bandwidth using a second amount of free memory;
determine that the used second amount of free memory is at least a second threshold, wherein the second threshold is greater than the first threshold; and
in response to the determination that the used second amount of free memory is at least the second threshold:
further reduce the allocated processing bandwidth to process the received instructions based on the used second amount of free memory; and
allocate processing bandwidth to perform garbage collection of the memory based on the allocated processing bandwidth to process the received instructions.

14. The non-transitory computer-readable medium of claim 13, wherein the processing circuitry is further to:
determine that the used second amount of free memory is at least the first threshold and at most the second threshold; and
in response to the determination that the used second amount of free memory is at least the first threshold and at most the second threshold:
reduce the allocated processing bandwidth to process the received instructions based on the used second amount of free memory.

15. The non-transitory computer-readable medium of claim 14, wherein to reduce the allocated processing bandwidth to process the received instructions the processing circuitry is to reduce the allocated processing bandwidth to process the received instructions in an inverse relationship with the used second amount of free memory.

16. The non-transitory computer-readable medium of claim 13, wherein in response to the determination that the used second amount of free memory is at least the second threshold the processing circuitry is to:
inversely modify each of the respective allocated processing bandwidths to (a) process the received instructions and (b) perform garbage collection about a processing bandwidth value of normal operation of the non-transitory computer-readable medium.

17. The non-transitory computer-readable medium of claim 13, wherein the processing circuitry is further to:
determine that the used second amount of used free memory is at least a third threshold; and
in response to the determination that the used second amount of free memory is at least the third threshold:
further allocate processing bandwidth to perform garbage collection; and
further reduce the allocated processing bandwidth to process the received instructions until the used second amount of free memory is at most a fourth threshold.

18. The non-transitory computer-readable medium of claim 17, wherein the processing circuitry is further to:
determine that the used second amount of free memory is at least the fourth threshold; and
in response to the determination that the used second amount of free memory is at least the fourth threshold:
halt the allocation of any processing bandwidth to process the received instructions; and
allocate all available processing bandwidth to perform garbage collection.
